(19) United States
(12) Patent Application Publication
(10) Pub. No.: US 2014/0283424 A1
(43) Pub. Date: Sep. 25, 2014

(54) TRANSLUCENT PET TAG COVER

(71) Applicant: Cathy S. Cope, North Las Vegas, NV (US)

(72) Inventor: Cathy S. Cope, North Las Vegas, NV (US)

(21) Appl. No.: 14/222,189

(22) Filed: Mar. 21, 2014

Related U.S. Application Data
(60) Provisional application No. 61/804,293, filed on Mar. 22, 2013.

(51) Int. Cl. G09F 3/18; G09F 3/00

(52) U.S. Cl. CPC G09F 3/185; G09F 3/00
USPC 40/303

(57) ABSTRACT

The invention is directed to covers, and more particularly to pet tag covers designed to reduce sound caused by movement and impact. Some embodiments of the invention are directed to a pet tag cover comprising two translucent cover halves and an adhesive edge. Each translucent cover half has an inner side and an outer side. The adhesive edge is located along the inner side of each translucent cover half. In another embodiment, at least one cover half further includes an inner side with an indent. Each indent is centered within the inner side and configured to receive a pet tag. In another embodiment, at least one inner side of a translucent cover edge defined the adhesive edge to be located between the edge of the inner side and the indent.

### CROSS REFERENCE TO RELATED APPLICATIONS

This application claims priority to U.S. Provisional Application No. 61/804,293, filed on Mar. 22, 2013, the entirety of which is incorporated herein by reference.

### COPYRIGHT NOTICE

A portion of this disclosure contains material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### BACKGROUND

The invention is directed to covers, and more particularly to pet tag covers designed to reduce sound caused by movement and impact.

Pet tags remain one of the most effective methods of keeping identification on domestic pets such cats and dogs. Such tags allow for easy identification of domestic pets in the event that they are lost and provide clear identification that pets have owners when in the hands of authorities or veterinary staff. The problem with current pet tags is that they make noise when a pet moves and the tag come in contact with metal surfaces on the pet collar or additional tags. This is commonly known as “jingling” and deters pet owners from using pet tags in order to not hear the disturbing sound or disturb others.

Previously, inventors developed pet tag covers in order to reduce or eliminate the jingling sound. Unfortunately these pet tags covers failed in a number of ways. First, these covers were not fitted to the pet tag itself. These uniform covers generated additional sounds instead of completely reducing the jingling noise. Second, many of the covers added significant weight and bulk to the pet tag itself, causing discomfort and possible irritation for the domestic pet wearing the pet tag.

Thus, there is a need to resolve one or more of the problems identified above, among other things.

### SUMMARY OF INVENTION

Some embodiments of the invention are directed to a pet tag cover comprising two translucent cover halves and an adhesive edge. Each translucent cover half has an inner side and an outer side. The adhesive edge is located along the inner side of each translucent cover half.

In another embodiment, at least one of the translucent cover halves further defines an opening. The opening is configured to receive a metal ring.

In another embodiment, at least one of the translucent cover halves further includes an outer side with a tapered edge.

In another embodiment, at least one cover half further includes an inner side with an indent. Each indent is centered within the inner side and configured to receive a pet tag.

In another embodiment, at least one inner side of a translucent cover edge defined the adhesive edge to be located between the edge of the inner side and the indent.

### BRIEF DESCRIPTION OF THE DRAWINGS

Other advantages of the invention will be readily appreciated as the same becomes better understood by reference to the following detailed description when considered in connection with the accompanying drawings:

FIG. 1 is an exploded view of a pet tag cover, according to an embodiment of the present invention;

FIG. 2 is a front view of a pet tag cover according to an embodiment of the present invention;

FIG. 3 is a representative drawing of a pet tag cover attached to a pet collar, according to an embodiment of the present invention;

FIG. 4 is a representative drawing of an industrial application of a pet tag cover, according to an embodiment of the present invention.

### DETAILED DESCRIPTION OF INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, and alterations and modifications in the illustrated device and method and further applications of the principles of the invention as illustrated therein, are herein contemplated as would normally occur to one skilled in the art to which the invention relates.

Referring to the figures, where like numerals indicate like or corresponding parts throughout the several views, systems and methods of the invention which are configured to cooperate with another in order to provide a bingo game with a roulette feature are described.

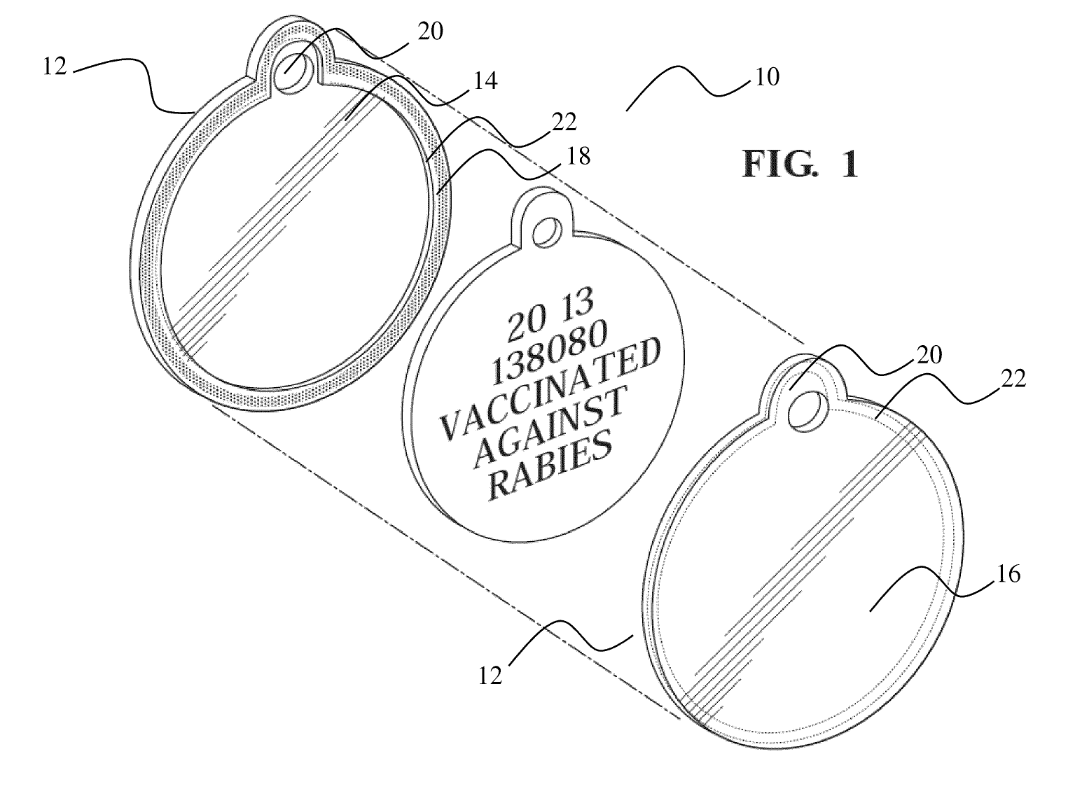

Referring to FIG. 1, a pet tag cover 10 is shown comprising two translucent cover halves 12. Each translucent cover half 12 has both an inner side 14 and an outer side 16. Furthermore, at least one of the inner sides 14 has an adhesive edge 18. The adhesive edge 18 goes along the entire edge of at least one inner side of a translucent cover half 12 and maintains a consistent width from the edge of the cover half 12 to the edge of the pet tag utilized. This ensures proper adhesion between the cover halves without affecting the appearance of the pet tag through the cover. The actual adhesive used may be any type of film adhesive. The translucent cover halves 12 may also be any type of translucent plastic or polymer material. The translucent cover halves 12 may also be of any varying shape and thickness in order to property accommodate a given pet tag. Both the types of material for the adhesive and the translucent cover halves are indicated as examples and not meant to be limiting in any way.

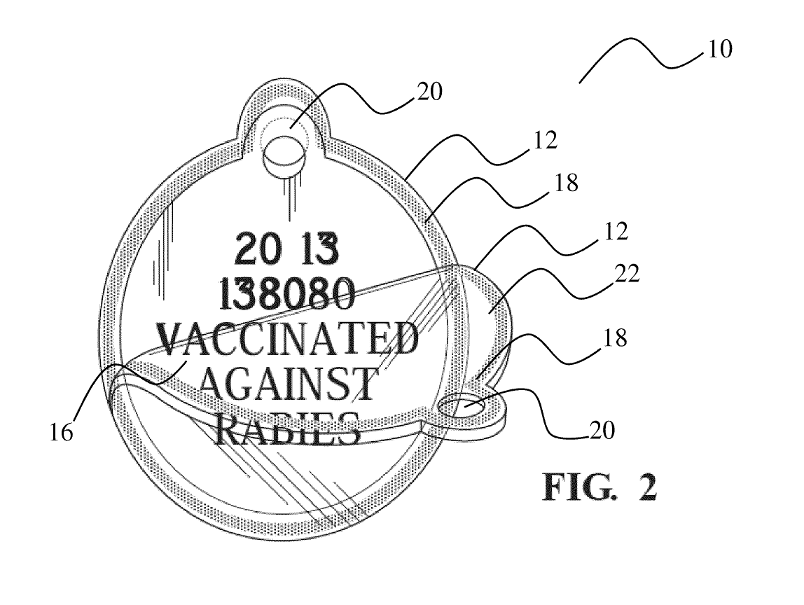

FIG. 2 shows a front view of the pet tag cover 10, according to an embodiment of the present invention. The cover 10 further includes an opening 20. The opening 20 is defined in order to allow the pet tag cover 10 and an included pet tag to hang from a metal ring (not shown) or similar mechanism. The present figure also shows the cover 10 including an indent 22 within at least one of the translucent cover halves 12. The indent 22 is centered within at least one of the inner sides 14 and is shaped to receive a pet tag. This indent ensures a secure hold of the pet tag by the cover 10 and also ensures even contact for the adhesive edge 18. In this particular embodiment, the width of the adhesive edge 18 extends between the edge of the translucent cover half 12 and the indent 22. The indent 22 may be even between both cover halves 12 or limited to one cover half 12 depending on the embodiment.

### INDUSTRIAL APPLICABILITY

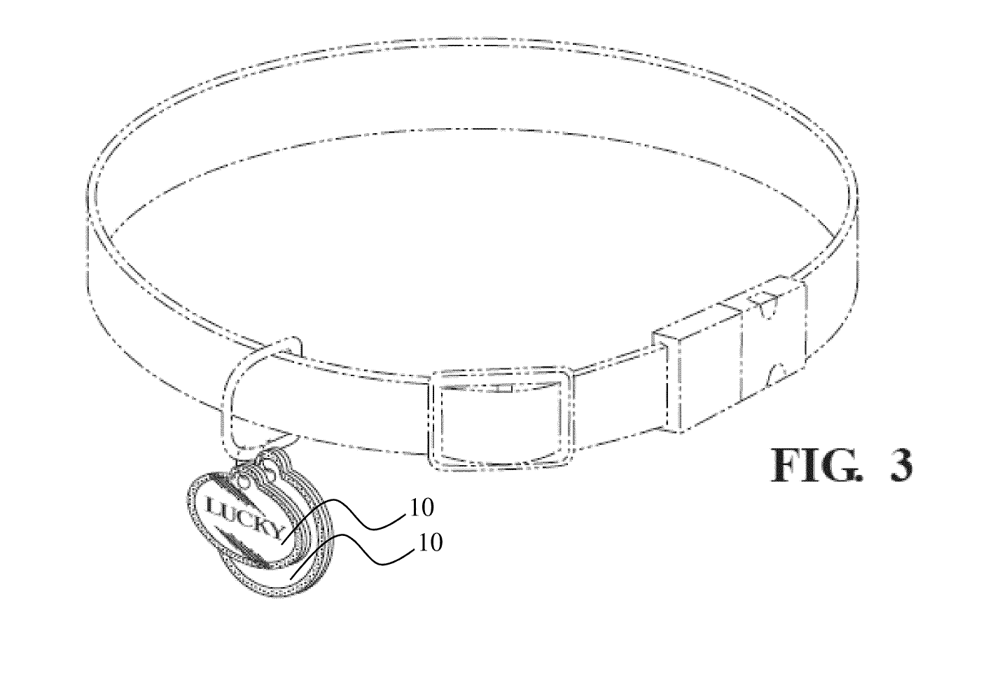

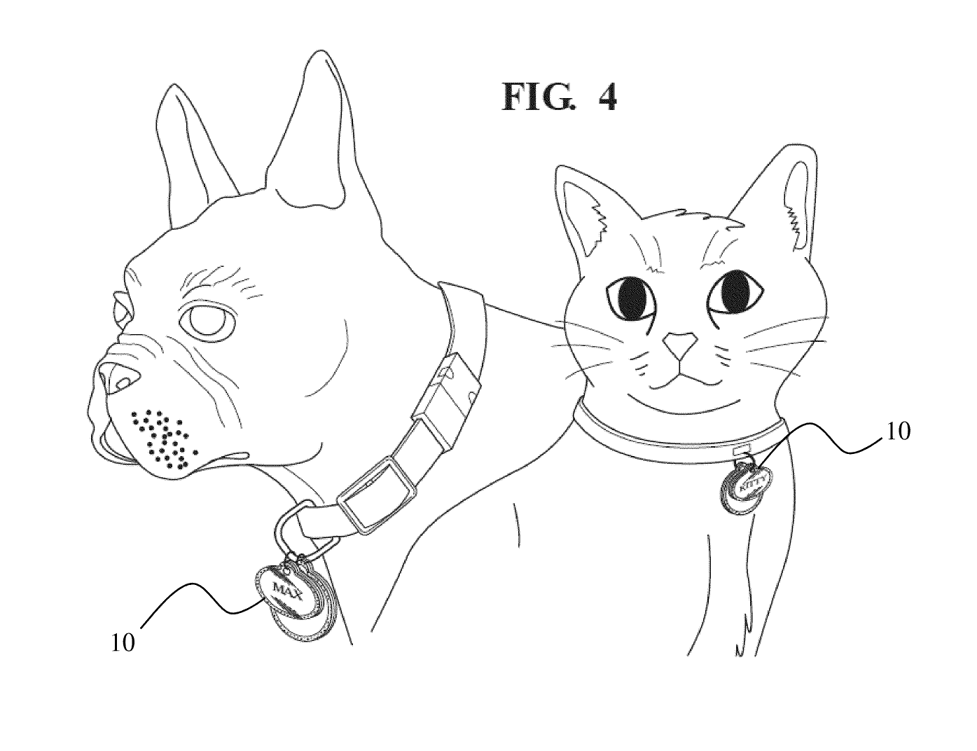

FIGS. 3 and 4 demonstrate an industrial application of the present invention in the form of domestic pet tag cover.

FIG. 3 shows the use of the cover 10 as attached a domestic pet cover. From this figure it can be seen that the cover 10 separates the included pet tag from interacting with additional pet tags, whether covered or not, or other surfaces in order to create noise.

FIG. 4 shows the active use of the cover 10 on a domestic pet.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the invention can be obtained from a study of the drawings, the disclosure, and the appended claims. The invention may be practiced otherwise than as specifically described within the scope of the appended claims.

Although specific features of various embodiments of the invention may be shown in some drawings and not in others, this is for convenience only. In accordance with the principles of the invention, any feature of a drawing may be referenced and/or claimed in combination with any feature of any other drawing.

While exemplary embodiments in accordance with the invention have been described herein and in the accompanying materials, it should also be understood that the foregoing along with the accompanying materials are illustrative of a few particular embodiments as well as principles of the invention, and that various modifications can be made by those skilled in the art without departing from the scope and spirit of the invention. Therefore, the described embodiments should not be considered as limiting of the invention in any way. Accordingly, the invention embraces alternatives, modifications and variations which fall within the spirit and scope of the invention as set forth in the claims, including equivalents thereto.

What is claimed is:

1. A pet tag cover comprising:
two translucent cover halves, each half having an outer side and an inner side; and
an adhesive edge along the inner side of each translucent cover half.

2. The pet tag cover, as in claim 1, wherein at least one cover half further defines an opening, said opening configured to receive a metal ring.

3. The pet tag cover, as in claim 1, wherein at least one cover half further includes an outer side with a tapered edge.

4. The pet tag cover, as in claim 1, wherein at least one cover half further includes an inner side with an indent, said indent centered within the inner side and configured to receive a pet tag.

5. The pet tag cover, as in claim 4, wherein at least one inner side further defines the adhesive edge to be located between the edge of the inner side and the indent.
